(19) United States
(12) Patent Application Publication
(10) Pub. No.: US 2002/0002455 A1
(43) Pub. Date: Jan. 3, 2002

(54) CORE ESTIMATOR AND ADAPTIVE GAINS FROM SIGNAL TO NOISE RATIO IN A HYBRID SPEECH ENHANCEMENT SYSTEM

(75) Inventors: ANTHONY J. ACCARDI, SOMERSET, NJ (US); RICHARD VANDERVOORT COX, NEW PROVIDENCE, NJ (US)

Correspondence Address: S H DWORETSKY AT&T CORP, PO BOX 4110, MIDDLETOWN, NJ, 07748

(73) Assignee: AT&T Corporation

(21) Appl. No.: 09/206,478

(22) Filed: Dec. 7, 1998

Related U.S. Application Data
(60) Provisional application No. 60/071,051, filed on Jan. 9, 1998.

(51) Int. Cl. G10L 15/26; G10L 21/02; G10L 15/20

(52) U.S. Cl. 704/226; 704/235; 704/233

(57) ABSTRACT

A speech enhancement system receives noisy speech and produces enhanced speech. The noisy speech is characterized by a spectral amplitude spanning a plurality of frequency bins. The speech enhancement system modifies the spectral amplitude of the noisy speech without affecting the phase of the noisy speech. The speech enhancement system includes a core estimator that applies to the noisy speech one of a first set of gains for each frequency bin. A noise adaptation module segments the noisy speech into noise-only and signal-containing frames, maintains a current estimate of the noise spectrum and an estimate of the probability of signal absence in each frequency bin. A signal-to-noise ratio estimator measures an a-posteriori signal-to-noise ratio and estimates an a-priori signal-to-noise ratio based on the noise estimate. Each one of the first set of gains is based on the a-priori signal-to-noise ratio, as well as the probability of signal absence in each bin and a level of aggression of the speech enhancement. A soft decision module computes a second set of gains that is based on the a-posteriori signal-to-noise ratio and the a-priori signal-to-noise ratio, and the probability of signal absence in each frequency bin.

### CROSS-REFERENCE TO RELATED APPLICATIONS

This application claims the priority benefit of provisional U.S. application Ser. No. 60/071,051, filed Jan. 9, 1998.

### BACKGROUND OF THE INVENTION

There are many environments where noisy conditions interfere with speech, such as the inside of a car, a street, or a busy office. The severity of background noise varies from the gentle hum of a fan inside a computer to a cacophonous babble in a crowded cafe. This background noise not only directly interferes with a listener's ability to understand a speaker's speech, but can cause further unwanted distortions if the speech is encoded or otherwise processed. Speech enhancement is an effort to process the noisy speech for the benefit of the intended listener, be it a human, speech recognition module, or anything else. For a human listener, it is desirable to increase the perceptual quality and intelligibility of the perceived speech, so that the listener understands the communication with minimal effort and fatigue.

It is usually the case that for a given speech enhancement scheme, a trade-off must be made between the amount of noise removed and the distortion introduced as a side effect. If too much noise is removed, the resulting distortion can result in listeners preferring the original noise scenario to the enhanced speech. Preferences are based on more than just the energy of the noise and distortion: unnatural sounding distortions become annoying to humans when just audible, while a certain elevated level of “natural sounding” background noise is well tolerated. Residual background noise also serves to perceptually mask slight distortions, making its removal even more troublesome.

Speech enhancement can be broadly defined as the removal of additive noise from a corrupted speech signal in an attempt to increase the intelligibility or quality of speech. In most speech enhancement techniques, the noise and speech are generally assumed to be uncorrelated. Single channel speech enhancement is the simplest scenario, where only one version of the noisy speech is available, which is typically the result of recording someone speaking in a noisy environment with a single microphone.

FIG. 1 illustrates a speech enhancement setup for N noise sources for a single-channel system. For the single channel case illustrated in FIG. 1, exact reconstruction of the clean speech signal is usually impossible in practice. So speech enhancement algorithms must strike a balance between the amount of noise they attempt to remove and the degree of distortion that is introduced as a side effect. Since any noise component at the microphone cannot in general be distinguished as coming from a specific noise source, the sum of the responses at the microphone from each noise source is denoted as a single additive noise term.

Speech enhancement has a number of potential applications. In some cases, a human listener observes the output of the speech enhancement directly, while in others speech enhancement is merely the first stage in a communications channel and might be used as a preprocessor for a speech coder or speech recognition module. Such a variety of different application scenarios places very different demands on the performance of the speech enhancement module, so any speech enhancement scheme ought to be developed with the intended application in mind. Additionally, many well-known speech enhancement processes perform very differently with different speakers and noise conditions, making robustness in design a primary concern. Implementation issues such as delay and computational complexity are also considered.

### I. Modified MMSE-LSA Approach

The modified Minimum Mean-Square Error Log-Spectral Amplitude (modified MMSE-LSA) estimator for speech enhancement was designed by David Malah and draws upon three main ideas: the Minimum Mean Square Error Log-Spectral Amplitude (MMSE-LSA) estimator (Y. Ephraim and D. Malah, “Speech Enhancement Using a Minimum Mean-Square Error Log-Spectral Amplitude Estimator,” IEEE Transactions on Acoustics, Speech, and Signal Processing, vol. ASSP-33, pp. 443-445, 1985); the soft decision approach (R. J. McAulay and M. L. Malpass, “Speech Enhancement Using a Soft-Decision Noise Suppression Filter,” IEEE Transactions on Acoustics, Speech, and Signal Processing, vol. ASSP-28, pp. 137-145, 1980); and a novel noise adaptation scheme. The modified MMSE-LSA speech enhancement system is a member of the class of STSA enhancement techniques and is schematically depicted in FIG. 2.

With reference to FIG. 2, the MMSE-LSA estimator 10 operates in the frequency domain and applies a gain to each DFT coefficient of the noisy speech that is computed from signal-to-noise ratio (SNR) estimates 12. A soft decision module 14 applies an additional gain in the frequency domain that accounts for signal presence uncertainty. A noise adaptation scheme 16 supplies estimates of current noise characteristics for use in the SNR calculations.

### I.A. The MMSE-LSA Estimator

We begin by assuming additive independent noise and that the DFT coefficients of both the clean speech and the noise are zero-mean, statistically independent, Gaussian random variables. We formulate the speech enhancement problem as

y[n]=x[n]+w[n] (1)

Taking the DFT of (1), we obtain

Yₖ=Xₖ+Wₖ (2)

We express the complex clean and noisy speech DFT coefficients in exponential form as

Xₖ=Aₖe^{J}^{^{φ}}^{k} (3)

Yₖ=Rₖe^{J}^{^{θ}}^{k} (4)

Now the MMSE-LSA estimate of Aₖ is the amplitude that minimizes the difference between log Aₖ and the logarithm of that amplitude in a MMSE sense:

$${\hat{A}}_{k} = {arg min}_{B} E [ {( log {A}_{k} - log B )}^{2} ] \qquad ( 5 )$$

The solution to (5) is the exponential of the conditional expectation (A. Papoulis, Probability, Random Variables, and Stochastic Processes, 3 ed. New York: McGraw-Hill, Inc., 1991):

Âₖ=exp(E[log Aₖ|Yₖ]) (6)

Therefore, to implement the MMSE-LSA estimator 10, we must scale the noisy speech DFT coefficients Yₖ so that they have the estimated amplitude Âₖ. Our estimate of the clean speech in the frequency domain is now

$${\hat{X}}_{k} = {\hat{A}}_{k} \frac{{Y}_{k}}{\vert {Y}_{k} \vert} \qquad ( 7 )$$

We are using the “noisy phase” in (7), since the phase of the DFT coefficients of the noisy speech is used in our estimate of the clean speech. The MMSE complex exponential estimator does not have a modulus of 1. (Y. Ephraim and D. Malah, “Speech Enhancement Using a Minimum Mean-Square Error Short-Time Spectral Amplitude Estimator,” IEEE Transactions on Acoustics, Speech, and Signal Processing, vol. ASSP-32, pp. 1109-1121, 1984). So when an optimal complex exponential estimator is combined with an optimal amplitude estimator, the resulting amplitude estimate is no longer optimal. When the estimate's modulus is constrained to be unity, however, the MMSE complex exponential estimator is the exponent of the noisy phase. In addition, the optimal estimator of the principal value of the phase is the noisy phase itself. This provides justification for using the MMSE-LSA estimator 10 to estimate Aₖ and to leave the noisy phase untouched, as indicated in (7).

The computation of the expectation in (6) is non-trivial and presented in the article by Y. Ephraim and D. Malah, “Speech Enhancement Using a Minimum Mean-Square Error Log-Spectral Amplitude Estimator,” IEEE Transactions on Acoustics, Speech, and Signal Processing, vol. ASSP-33, pp. 443-445, 1985, where Âₖ is shown to be:

Âₖ=G(ξₖ,γₖ)·Rₖ (8)

where

$$\begin{matrix}G ( {ξ}_{k} , {γ}_{k} ) = \frac{{ξ}_{k}}{1 + {ξ}_{k}} exp ( \frac{1}{2} {\int }_{{υ}_{k}}^{∞} \frac{{ⅇ}^{- t}}{t} ⅆ t ) & ( 9 ) \\ {υ}_{k} = \frac{{ξ}_{k}}{1 + {ξ}_{k}} {γ}_{k} & ( 10 )\end{matrix}$$

ξₖ=λₓ(k)/λ_{w}(k) (11)

γₖ=Rₖ²/λ_{w}(k) (12)

λₓ(k)=E[|Xₖ|²]=E[|Aₖ|²] (13)

λ_{w}(k)=E[|Wₖ|²] (14)

Here λₓ(k) and λ_{w}(k) defined in (13) and (14) are the energy spectral coefficients of the clean speech and the noise, respectively. As defined in (11) and (12), the quantities εₖ and γₖ can be interpreted as signal-to-noise ratios. We will denote εₖ as the a-priori SNR, as it is the ratio of the energy spectrum of speech to that of the noise prior to the contamination of the speech by the noise. Similarly, we will call γₖ the a-posteriori SNR, as it is the ratio of the energy of the current frame of noisy speech to the energy spectrum of the noise, after the speech has been contaminated.

In order to compute G(εₖ,γₖ) as given in (9), we must first estimate these SNR's εₖ and γₖ. Malah's noise adaptation scheme 16 provides an estimate of λ_{w}(k), so the a-posteriori SNR γₖ is straightforward to estimate since Rₖ is readily computed from the noisy speech. However, the a-priori SNR εₖ is somewhat more difficult to estimate. It turns out that the Maximum Likelihood (ML) estimate of εₖ does not work very well. In the article by Y. Ephraim and D. Malah, “Speech Enhancement Using a Minimum Mean-Square Error Short-Time Spectral Amplitude Estimator,” IEEE Transactions on Acoustics, Speech, and Signal Processing, vol. ASSP-32, pp. 1109-1121, 1984, the shortcomings of the ML estimate are discussed and a “decision directed” estimation approach is considered. The key idea is that under our assumption of Gaussian DFT coefficients, the a-priori SNR can be expressed in terms of the a-posteriori SNR as

γₖ=E[γₖ−1] (15)

For each frame of noisy speech, we can then take a convex combination of our two expressions (11) and (15) for εₖ, after dropping the expectation operators, to obtain an estimate for the a-priori SNR using previous values of Âₖ and \hat{λ}ₖ. For the nₜₕ frame we have

$${\hat{ξ}}_{k} ( n ) = α \frac{{\hat{A}}_{k}^{2} ( n - 1 )}{{\hat{λ}}_{w} ( k , n - 1 )} + ( 1 - α ) P [ {\hat{γ}}_{k} ( n ) - 1 ] \\ where \\ P [ x ] = \{ \begin{matrix}x & if x \geq 0 \\ 0 & otherwise\end{matrix} \qquad ( 16 )$$

The P[x] function is used to clip the a-posteriori SNR γₖ to 1 if a smaller value is calculated, and 0≦α≦1.

This “decision directed” estimate is mainly responsible for the elimination of musical noise artifacts that plague earlier speech enhancement algorithms. (0. Cappé, “Elimination of the Musical Noise Phenomenon with the Ephraim and Malah Noise Suppressor,” IEEE Transactions on Speech and Audio Processing, vol. 2, pp. 345-349, 1994). The intuition behind this mechanism is that for large a-posteriori SNRs, the a-priori SNR follows the a-posteriori SNR with a single frame delay. This allows the enhancement scheme to adapt quickly to any sudden changes in the noise characteristics that the noise adaptation scheme perceives. However, for small a-posteriori SNRs, the a-priori SNR is a highly smoothed version of the a-posteriori SNR. Since the a-priori SNR has a major impact in determining the gain as seen in (9), there are no sudden fluctuations in gain at any fixed frequency from frame to frame when there is a good deal of noise present. This greatly reduces the musical noise phenomenon.

We can choose α to trade-off between the degree of noise reduction and the overall distortion. α must be close to 1 (>0.98) in order to achieve the greatest musical noise reduction effect. (O. Cappé, “Elimination of the Musical Noise Phenomenon with the Ephraim and Malah Noise Suppressor,” IEEE Transactions on Speech and Audio Processing, vol. 2, pp. 345-349, 1994). The higher a, however, the more aggressive the algorithm is in removing the residual noise, which causes additional speech distortion. In fact, the easiest way to trade-off between aggression and distortion is through changing a, which has the awkward side effect of disturbing the smoothing properties discussed above.

### I.B. Signal Presence Uncertainty

The above analysis assumes that there is speech present in every frequency bin of every frame of the noisy speech. This is generally not the case, and there are two well-established ways of taking advantage of this situation.

The first, called “hard decision”, treats the presence of speech in some frequency bin as a time-varying deterministic condition that can be determined using classical detection theory. The second, “soft decision”, treats the presence of speech as a stochastic process with a changing binary probability distribution. (R. J. McAulay and M. L. Malpass, “Speech Enhancement Using a Soft-Decision Noise Suppression Filter,” IEEE Transactions on Acoustics, Speech, and Signal Processing, vol. ASSP-28, pp. 137-145, 1980). The soft decision approach has been found to be more successful in speech enhancement. (Y. Ephraim and D. Malah, “Speech Enhancement Using a Minimum Mean-Square Error Short-Time Spectral Amplitude Estimator,” IEEE Transactions on Acoustics, Speech, and Signal Processing, vol. ASSP-32, pp. 1109-1121, 1984). A hard decision approach can in fact lead to musical noise. When the decision oscillates between signal presence and absence in time for some frequency bin, an enhancement scheme that greedily eliminates frequency components containing only noise would produce tonal artifacts at that frequency. Following this outline, we define two states for each frequency bin k. H₀^{k} denotes the state where the speech signal is absent in the k^{th} bin, while H₁^{k} is the state where the signal is present in the k^{th} bin. Now our estimate of log Aₖ is given by

E[log Aₖ|Yₖ,H₁^{k}]Pr(H₁^{k}|Yₖ)+E[log Aₖ|Yₖ,H₀^{k}]Pr(H₀^{k}|Yₖ) (17)

Since E[log Aₖ|Yₖ,H₀^{k}]=0, soft decision entails weighting our previous estimate of log Aₖ by Pr(H₁^{k}|Y^{k}). To compute this weighting factor, we first expand Pr(H₁^{k},Yₖ) in two different ways:

Pr(H₁^{k}|Yₖ)·Pr(Yₖ)=Pr(Yₖ|H₁^{k})·Pr(H₁^{k}) (18)

Also,

Pr(Yₖ)=Pr(Yₖ|H₁^{k})·Pr(H₁^{k})+Pr(Yₖ|H₀^{k})·Pr(H₀^{k}) (19)

From (18) and (19) we can solve for Pr(H₁^{k}|Yₖ) and express it in terms of the likelihood function Λ(k):

$$\begin{matrix}Pr ( {H}_{1}^{k} \vert {Y}_{k} ) = \frac{Λ ( k )}{1 + Λ ( k )} \\ where & ( 20 ) \\ Λ ( k ) = {μ}_{k} \frac{Pr ( {Y}_{k} \vert {H}_{1}^{k} )}{Pr ( {Y}_{k} \vert {H}_{0}^{k} )} & ( 21 ) \\ {μ}_{k} = Pr ( {H}_{1}^{k} ) / Pr ( {H}_{0}^{k} ) = \frac{1 - {q}_{k}}{{q}_{k}} & ( 22 )\end{matrix}$$

Here qₖ is the a-priori probability of signal absence in the k^{th} bin, and A(k) is clearly the likelihood function from classical detection theory. (A. Papoulis, Probability, Random Variables, and Stochastic Processes, 3 ed. New York: McGraw-Hill, Inc., 1991). With our Gaussian distribution assumptions on Yₖ, it is straightforward to calculate Λ(k):

$$Λ ( k ) = \frac{1 - {q}_{k}}{{q}_{k}} \cdot \frac{1}{1 + {η}_{k}} exp {( \frac{{η}_{k}}{1 + {η}_{k}} {γ}_{k} )}_{{η}_{k} = \frac{{ξ}_{k}}{1 - {q}_{k}}} \qquad ( 23 )$$

where the SNR's γₖ and εₖ can be estimated in the same manner as described in Section I.A.

### I.C. Noise Adaptation

An important development for the modified MMSE-LSA speech enhancement technique is the noise adaptation scheme 16, which allows the speech enhancement technique to handle non-stationary noise. The adaptation proceeds in two steps; the first identifies all the spectral coefficients in the current frame that are reasonably good representations of the noise, and the second adapts the current noise estimate to this new information.

Direct spectral information about the noise can become available when a frame of the noisy speech is a “noise-only” frame, meaning that the speech contribution during that time period is negligible. In this case, the entire noise spectrum estimate can be updated. Additionally, even if a frame contains both speech and noise, there may still be some “noise-only” frequency bins so that the speech contribution within certain frequency ranges is negligible during the current frame. Here we can update the corresponding spectral components of our noise estimate accurately.

The process of deciding whether a given frame is a noise-only frame is dubbed “segmentation”, and the decision is based on the a-posteriori SNR estimates γₖ. Under our Gaussian distribution assumptions on Yₖ, we can compute the probability density function ƒ(γₖ) for γₖ, which turns out to be an exponential distribution with mean and standard deviation 1+εₖ given by

$$f ( {γ}_{k} ) = \frac{1}{1 + {ξ}_{k}} exp ( \frac{- {γ}_{k}}{1 + {ξ}_{k}} ) \qquad ( 24 )$$

We declare a frame of speech to be noise-only if both our average (over k) estimate of the a-posteriori SNRs is low and the average of our estimate of the variance of the a-posteriori SNR estimator is low. That is, a frame is noise-only when

\overline{γ}≦\overline{γ}_{Threshold} and \overline{ξ}≦σ_{Threshold}−1 (25)

When a noise-only frame is discovered, we update all the spectral components of our noise estimate by averaging our estimates for the previous frame with our new estimates. So our noise spectral estimate for the k^{th} frequency bin and the n^{th} frame is given by:

\hat{λ}_{w}(k,n)=α_{w}\hat{λ}_{w}(k,n−1)+(1−α_{w})R_{w}² (26)

where α_{w} is the forgetting factor of the update equation, which is dynamically updated based on the average estimate of γₖ. In this manner, the forgetting factor is directly related to the current value of \hat{γ} so that the lower \hat{γ} is, the better our estimate of the noise spectrum, and therefore we discard our previous noise spectral estimates more quickly.

The situation for dealing with noise-only frequency bins for frames with signal present is quite similar, except the individual SNR estimates for each frequency bin are used instead of their averages. There is one main difference; since we have an estimate of the probability that each bin contains no signal present (qₖ from our soft decision discussion in Section I.B.), we can use this to refine our update of the forgetting factor for each frequency bin.

The impact of this noise adaptation scheme 16 is dramatic. The complete modified MMSE-LSA enhancement technique is capable of adapting to great changes in noise volume in only a few frames of speech, and has demonstrated promising performance in dealing with highly non-stationary noise, such as music.

### II. Signal Subspace Approach

Yariv Ephraim and Harry L. Van Trees developed a signal subspace approach (Y. Ephraim and H. L. V. Trees, “A Signal Subspace Approach for Speech Enhancement,” IEEE Transactions on Speech and Audio Processing, vol. 3, pp. 251-266, 1995) that provides a theoretical framework for understanding a number of classical speech enhancement techniques, and allows for the application of external criteria to control enhancement performance. The basic idea is that the vector space of the noisy speech can be decomposed into a signal-plus-noise subspace and a noise-only subspace. Once identified, the noise-only subspace can be eliminated and then the speech estimated from the remaining signal-plus-noise subspace. We assume that the full space has dimension K and the signal-plus-noise subspace has dimension M<K.

Say we have clean speech x[n] that is corrupted by independent additive noise w[n] to produce a noisy speech signal y[n]. We constrain ourselves to estimating x[n] using a linear filter H, and will initially consider w[n] to be a white noise process with variance σ_{w}². In vector notation, we have

y=x+w (27)

\hat{x}=Hy (28)

We can decompose the residual error into a term solely dependent on the clean speech, called the signal distortion rₓ, and a term solely dependent on the noise, called the residual noise r_{w}:

$$\begin{matrix}r = \hat{x} - x \\ = ( H - I ) x + Hw \\ = {r}_{x} + {r}_{w}\end{matrix} \qquad ( 29 )$$

In (29) we have explicitly identified the trade-off between residual noise and speech distortion. Since different applications could require different trade-offs between these two factors, it is desirable to perform a constrained minimization using functions of the distortion and residual noise vectors. Then the constraints can be selected to meet the application requirements.

### II.A. Time Domain Constrained Estimator

Two different frameworks for performing a constrained minimization using functions of the residual noise and signal distortion are presented in the article by Y. Ephraim and H. L. V. Trees, “A Signal Subspace Approach for Speech Enhancement,” IEEE Transactions on Speech and Audio Processing, vol. 3, pp. 251-266, 1995. The first examines the energy in these vectors and results in a time domain constrained estimator. We define

\overline{ε}ₓ²=trE[rₓrₓ^{#}]=tr{(H−I)R_{y}(H−I)^{#}} (30)

to be the energy of the signal distortion vector rₓ, and similarly define

\overline{ε}_{w}²=trE[r_{w}r_{w}^{#}]=σ_{w}²tr{HH^{#}} (31)

to be the energy of the residual noise vector r_{w}.

We desire to minimize the energy of the signal distortion while constraining the energy of the residual noise to be less than some fraction Kα of the noise variance σ_{w}²:

$${min}_{H} {\overline{ϵ}}_{x}^{2} subject to {\overline{ϵ}}_{w}^{2} / K \leq {ασ}_{w}^{2} \qquad ( 32 )$$

The solution to the constrained minimization problem in (32) involves first the projection of the noisy speech signal onto the signal-plus-noise subspace, followed by a gain applied to each eigenvalue, and finally the reconstruction of the signal from the signal-plus-noise subspace. The gain for the m^{th} eigenvalue is a function of the Lagrange multiplier μ, and is given by

$${g}_{μ} ( m ) = \frac{{λ}_{x} ( m )}{{λ}_{x} ( m ) + {μσ}_{w}^{2}} \qquad ( 33 )$$

where λₓ(m) is the m^{th} eigenvalue of the clean speech.

Thus, the enhancement system, which is schematically illustrated in FIG. 3, can be implemented as a Karhunen-Loève Transform (KLT) 24 which receives a noisy signal, followed by a set of gains (G_{1,} . . . , G_{N}) 26, and ending with an inverse KLT 28 which outputs an enhanced signal.

Ephraim shows that μ is uniquely determined by our choice of the constraint α, and demonstrates how the generalized Wiener filter in (33) can implement linear MMSE estimation and spectral subtraction for specific values of μ and certain approximations to the KLT.

### II.B. Spectral Domain Constrained Estimator

To provide a tighter means of control over the trade-off between residual noise and signal distortion, Ephraim derives a spectral domain constrained estimator (Y. Ephraim and H. L. V. Trees, “A Signal Subspace Approach for Speech Enhancement,” IEEE Transactions on Speech and Audio Processing, vol. 3, pp. 251-266, 1995) which minimizes the energy of the signal distortion while constraining each of the eigenvalues of the residual noise by a different constant proportion of the noise variance:

$${min}_{H} {\overline{ϵ}}_{x}^{2} subject to E [ {\vert {u}_{k}^{\#} {r}_{w} \vert}^{2} ] \leq {α}_{k} {σ}_{w}^{2} \qquad ( 34 )$$

Here uₖ is the k^{th} eigenvector of the noisy speech, and the constraint is applied for each k in the signal-plus-noise subspace. The form of the solution to this constrained minimization is very similar to the time domain constrained estimator illustrated in FIG. 3; the only difference is that the eigenvalue gains are given by

g(m)=\sqrt{αₖ} (35)

instead of the result in (33).

Now with such freedom over the constraints αₖ, the difficulty arises as to how to optimally choose these constants to obtain a reasonable speech enhancement system. One choice Ephraim investigated is

αₖ=exp{−νσ_{w}²/λₓ(k)} (36)

where ν is a constant that determines the level of noise suppression, or the aggression level of the enhancement algorithm. The constraints in (36) effectively shape the noise so it resembles the clean speech, which takes advantage of the masking properties of the human auditory system. This choice of functional form for αₖ is an aggressive one.

There is no treatment of noise distortion in this signal subspace approach, and it turns out that the residual noise in the enhanced signal can contain artifacts so annoying that the result is less desirable than the original noisy speech. Therefore, when using this signal subspace framework it is desirable to aggressively reduce the residual noise at the possibly severe cost of increased signal distortion.

### II.C. Reverse Spectral Domain Constrained Estimator

The spectral domain constrained estimator can be placed in a framework that will substantially reduce the noise distortion. In such scenarios, it might be advantageous to use a variant of Ephraim's spectral domain constrained estimator. Here we minimize the residual noise with the signal distortion constrained:

$${min}_{H} {\overline{ϵ}}_{w}^{2} such that E [ {\vert {u}_{k}^{\#} {r}_{y} \vert}^{2} ] \leq {α}_{k} {λ}_{y , k} \qquad ( 37 )$$

Since H could have complex entries, we set the Jacobians of both the real and imaginary parts of the Lagrangian from (37) to zero in order to obtain the first order conditions, expressed in matrix form as

HR_{w}+UΛ_{μ}U^{#}(H−I)R_{y}=0 (38)

where Λ_{μ}=diag(μ₁, . . . , μ_{K}) is a diagonal matrix of Lagrange multipliers. Applying the eigendecomposition of R_{y} and using the assumption that the noise is white, we obtain:

σ_{w}²Q+Λ_{μ}QΛ_{y}=Λ_{μ}Λ_{y} (39)

where

Q=U^{#}HU (40)

We note that a possible solution to the constrained minimization is obtained when Q is diagonal with elements given by

$${q}_{kk} = \{ \begin{matrix}\frac{{μ}_{k} {λ}_{y , k}}{{σ}_{w}^{2} + {μ}_{k} {λ}_{y , k}} & k = 1 , … , M \\ 0 & k = M + 1 , … , K\end{matrix} \qquad ( 41 )$$

which satisfies (39). For this Q, we have

E[|uₖ^{#}r_{y}|²]=λ_{y,k}(qₖₖ−1)² (42)

Now for the non-zero constraints in (37) to hold with equality, we must have

qₖₖ=1−\sqrt{αₖ} (43)

and

$${μ}_{k} = \frac{{σ}_{w}^{2}}{{λ}_{y , k} \sqrt{{α}_{k}}} ( 1 - \sqrt{{α}_{k}} ) \qquad ( 44 )$$

Since we see from (44) that μₖ≧0, this proposed solution satisfies the Kuhn-Tucker necessary conditions for the constrained minimization.

We conclude that H is given by

$$H = {UQU}^{\#} \\ Q = diag ( {q}_{11} , … , {q}_{KK} ) \\ {q}_{kk} = \{ \begin{matrix}1 - \sqrt{{α}_{k}} & k = 1 , … , M \\ 0 & k = M + 1 , … , K\end{matrix} \qquad ( 45 )$$

Thus the reverse spectral domain constrained estimator has a form very similar to that of our previous signal subspace estimators. The implementation of (45) is given in FIG. 3 with the gains

g(m)=1−\sqrt{αₖ} (46)

### SUMMARY OF THE INVENTION

According to an exemplary embodiment of the invention, a speech enhancement system receives noisy speech and produces enhanced speech. The noisy speech is characterized by spectral coefficients spanning a plurality of frequency bins and contains an original noise. The speech enhancement system includes a noise adaptation module. The noise adaptation module receives the noisy speech, and segments the noisy speech into noise-only frames and signal-containing frames. The noise adaptation module determines a noise estimate and a probability of signal absence in each frequency bin. A signal-to-noise ratio (SNR) estimator is coupled to the noise adaptation module. The signal-to-noise ratio estimator determines a first signal-to-noise ratio and a second signal-to-noise ratio based on the noise estimate. A core estimator coupled to the signal-to-noise ratio estimator receives the noisy speech. The core estimator applies to the spectral coefficients of the noisy speech one of a first set of gains for each frequency bin in the frequency domain without discarding the noise-only frames. The core estimator outputs noisy speech having a residual noise.

Each one of the first set of gains is determined based on the second signal-to-noise ratio, a level of aggression, the probability of signal absence in each frequency bin, or combinations thereof. The core estimator constrains the spectral density of the spectral coefficients of the residual noise to be below a constant proportion of the spectral density of the spectral coefficients of the original noise. A soft decision module coupled to the core estimator and to the signal-to-noise ratio estimator determines a second set of gains that is based on the first signal-to-noise ratio, the second signal-to-noise ratio and the probability of signal absence in each frequency bin. The soft decision module applies the second set of gains to the spectral coefficients of the noisy speech containing the residual noise and outputs enhanced speech.

According to an aspect of the invention, noisy speech that is characterized by spectral coefficients spanning a plurality of frequency bins and that contains an original noise is enhanced by segmenting the noisy speech into noise-only frames and signal-containing frames and determining a noise estimate and a probability of signal absence in each frequency bin. A first signal-to-noise ratio and a second signal-to-noise ratio are determined based on the noise estimate. A first set of gains is determined based on the second signal-to-noise ratio, a level of aggression, the probability of signal absence in each frequency bin, or combinations thereof. The first set of gains is applied to the spectral coefficients of the noisy speech without discarding the noise-only frames to produce noisy speech containing a residual noise, such that the spectral density of the spectral coefficients of the residual noise is maintained below a constant proportion of the spectral density of the spectral coefficients of the original noise. A second set of gains is applied to the noisy speech containing the residual noise to produce enhanced speech. The spectral amplitude of the noisy speech is modified without affecting the phase of the noisy speech. During a noise-only frame, a constant gain is applied to the noise to avoid noise structuring.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 illustrates a speech enhancement setup for N noise sources for a single-channel system;

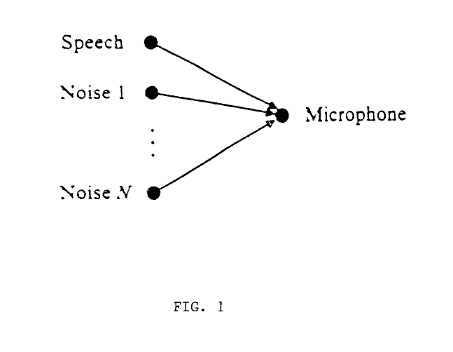

FIG. 2 is a block diagram of a modified MMSE-LSA speech enhancement system;

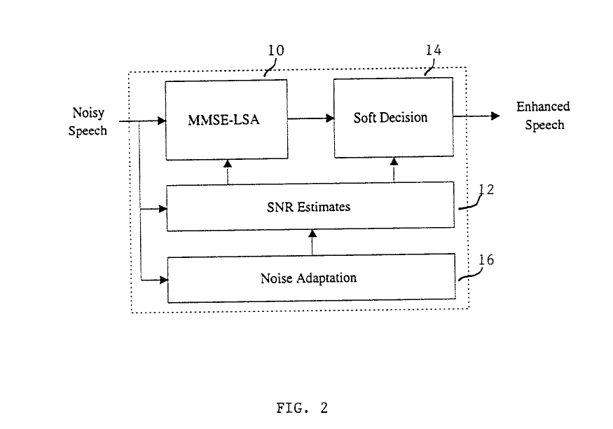

FIG. 3 is a block diagram of a signal subspace estimator;

FIG. 4 is a block diagram of a speech enhancement system in accordance with the principles of the invention;

FIG. 5 is a block diagram of a first embodiment of the core estimator of the speech enhancement system illustrated in FIG. 4; and

FIG. 6 is a block diagram of a second embodiment of the core estimator of the speech enhancement system illustrated in FIG. 4.

### DETAILED DESCRIPTION

### III. Hybrid Speech Enhancement System

Ephraim's signal subspace approach (see Section II.) and Malah's modified MMSE-LSA algorithm (see Section I.) have very different strengths and weaknesses.

Ephraim's signal subspace approach provides a simple but powerful framework for trading-off between the degree of noise suppression and signal distortion. This framework is general enough to incorporate many different criteria, including perceptual measures for general applications. This provides a good deal of flexibility when attempting to specialize an enhancement algorithm for a specific application. However, the technique offers no means for controlling noise distortion and handling non-stationary noise. Noise can be so severely distorted that the enhanced signal is less desirable than the original noisy signal, even though the noise energy has been suppressed. This forces one to operate the signal subspace algorithm in a very aggressive mode, so that the noise is practically eliminated but signal distortion may be high.

Malah's modified MMSE-LSA approach was carefully designed to reduce noise distortion and adapt to non-stationary noise. The approach is quite robust when presented with different types and levels of noise. The main difficulty is that the trade-off between the degree of noise suppression and signal distortion is awkward and is best performed by varying α in (16), which has undesirable side effects on the noise distortion. This provides very little flexibility when trying to adapt the algorithm to fit a particular application.

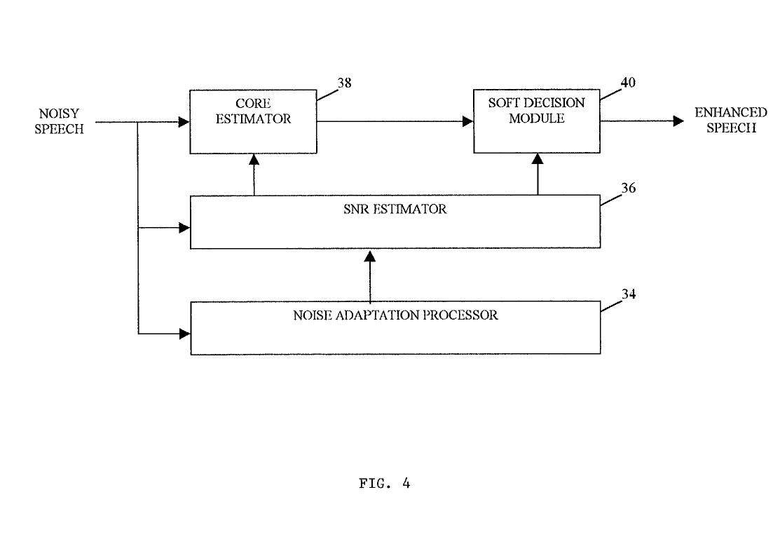

The present invention combines the strengths of these two approaches in order to generate a robust and flexible speech enhancement system that performs just as well. FIG. 4 schematically illustrates a speech enhancement system in accordance with the principles of the invention. The speech enhancement system shown in FIG. 4 receives noisy speech and produces enhanced speech. The speech enhancement system includes a noise adaptation processor 34 that receives the noisy speech that contains an original noise. A signal-to-noise ratio (SNR) estimator 36 is coupled to the noise adaptation processor 34 and receives the noisy speech containing the original noise. A core estimator 38 is coupled to the SNR estimator 36 and receives the noisy speech containing the original noise. The core estimator 38 applies a first set of gains in the frequency domain to the noisy speech containing the original noise without discarding noise-only frames, and outputs noisy speech containing a residual noise. A soft decision module 40 is coupled to the core estimator 38 and to the SNR estimator 36. The soft decision module 40 applies a second set of gains to the noisy speech and outputs the enhanced speech.

The noise adaptation processor 34 acts independently from the remainder of the modules. It is essential for many STSA speech enhancement algorithms to have an accurate estimate of the noise. Malah's modified MMSE-LSA approach, for example, is particularly effective in tracking non-stationary noise, especially noise with varying intensity levels. The decision directed estimation approach is buried in the SNR estimator 36, which smoothes estimates between frames when the SNR becomes poor. We have seen that the effect is to reduce noise distortion when the gain applied depends heavily on these SNR estimates. The soft decision module 40 has broad applicability, and could be considered part of the core estimator 38. Since this technique has proven most effective in handling the uncertainty of signal presence in certain frequency bands for different estimators, we consider the soft decision module 40 to be a separate entity.

### III. A. Signal Subspace as a Core Estimator

Our first insight is that we can substitute anything we desire in the core estimator 38 block of FIG. 4 and take advantage of the supporting structure as long as the effective gain depends heavily on the SNR estimates provided. Our intuition is that this choice of core estimator 38 might depend on the desired application. For our present purpose, however, we will use the spectral domain constrained version of the signal subspace approach as the core estimator 38 in an effort to take advantage of its aggressive noise suppression properties and flexibility.

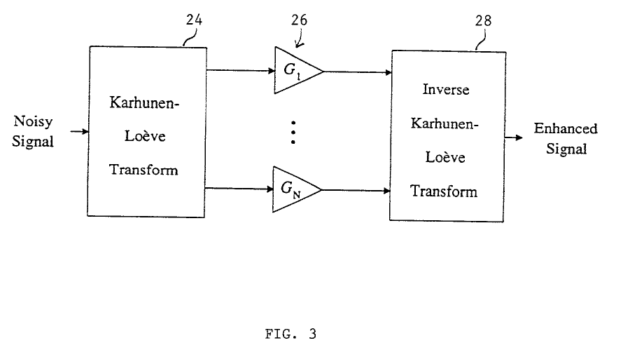

We modify the signal subspace approach so as to satisfy our constraints on the core estimator 38. The first modification to the signal subspace approach is using a Discrete Fourier Transform (DFT) in place of the KLT (24, FIG. 3). Since the first step of the signal subspace approach is to decompose the noisy speech into a noise-only subspace and a speech-plus-noise subspace and throw away the noise-only subspace, the approach takes advantage of the uncertainty of signal presence. When the KLT used in the signal subspace estimator is approximated with a Discrete Fourier Transform (DFT), this step is precisely a hard decision with zero gain applied to the frequency bins that contain pure noise. Such an approach leads to unpleasant noise distortion properties. The second modification to the signal subspace approach is to skip this noise-only subspace cancellation step.

Adapting the signal subspace approach to be a function of our SNR estimates is a bit more troublesome. The first difficulty is that the signal subspace approach assumes the noise is white, and to be a function of SNR's for each frequency bin implies that the noise model must be generalized. We have approximated the KLT with the DFT, and will now consider applying the signal subspace approach to a whitened version of the noisy speech. Say W is the whitening filter for the noise w. Then, after applying H to the whitened noisy speech Wy we obtain an estimate of Wx. Solving for \hat{x}, we have

\hat{x}=W⁻¹HWy (47)

where

H=UQU^{#} (48)

W=UW_{F}U^{#} (49)

Since we are using a DFT approximation to the KLT, U^{#} is the DFT matrix operator and U is the inverse DFT matrix operator. In (49), W_{F} is the frequency domain implementation of the whitening filter. Therefore W_{F} is a diagonal matrix, and Q is diagonal as derived in Section II.B. Substituting (48) and (49) into (47) and simplifying, we obtain

$$\begin{matrix}\hat{x} = {UW}_{F}^{- 1} {QW}_{F} {U}^{\#} y \\ = {UQU}^{\#} y \\ = Hy\end{matrix} \qquad ( 50 )$$

We have shown that whitening the signal, applying the signal subspace technique, and then applying the inverse of the whitening filter is equivalent to applying the signal subspace technique to the colored noise directly. The constraint, however, is modified. For the whitened noisy input, we now have

E[|uₖ^{#}\tilde{r}_{w}|²]≦αₖ\tilde{σ}_{w}² (51)

where

\tilde{r}_{w}=HWw (52)

\tilde{σ}_{w}²=E[|uₖ^{#}Ww|²] (53)

So \tilde{r}_{w} given in (52) is the residual whitened noise, and \tilde{σ}_{w}² given in (53) is the variance of this whitened noise. Since, according to the principles of the invention, we are using the DFT approximation to the KLT, the expectations in (51) and (53) are energy spectral density coefficients of the residual whitened noise and the whitened noise respectively. Therefore, dividing the k^{th} constraint given in (51) by the magnitude squared of the k^{th} component of the whitening filter in the frequency domain |W_{Fk}|², we obtain our new constraint:

Sᵣ_{_{w}}ᵣ_{_{w}}(k)≦αₖS_{ww}(k) (54)

Here Sᵣ_{_{w}}ᵣ_{_{w}}(k) and S_{ww}(k) are the k^{th} spectral coefficients of the residual noise and original noise, respectively.

The final step is to choose the constant constraints αₖ in (54). For white noise, Ephraim found that αₖ=exp{−νσ_{w}²/λₓ(k)} was a good selection for aggressive noise suppression. For the DFT approximation to the KLT, we have λₓ(k)=Sₓₓ(k). To extend the technique to colored noise, we have determined to try

$$\begin{matrix}{α}_{k} = exp \{ - υ \cdot {S}_{ww} ( k ) / {S}_{xx} ( k ) \} \\ = exp \{ - υ / {ξ}_{k} \}\end{matrix} \qquad ( 55 )$$

In (55), we have ensured that the resulting gain depends heavily on the estimate of the a-priori SNR 86 ₖ. In this manner, we heavily base our core estimator on the decision-directed estimate of ξₖ and benefit from the resulting reduction in musical noise.

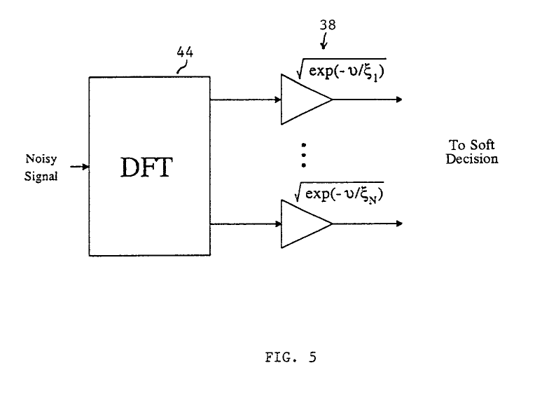

A first embodiment of our new core estimator 38 (FIG. 4) for the hybrid speech enhancement system is illustrated in FIG. 5 along with a DFT 44. The first embodiment of the core estimator 38 is coupled to the DFT 44. The DFT 44 receives the noisy signal and converts it into DFT coefficients in the frequency domain. The core estimator 38 includes a set of gains in accordance with (55), which is applied in the frequency domain to the DFT spectral coefficients of the noisy signal. One of the set of gains is applied to each DFT coefficient of the noisy speech by the core estimator 38. The DFT coefficients of the noisy signal are passed from the core estimator 38 to the soft decision module 40 (FIG. 4) for further enhancement.

### III.B. Differences with the Modified MMSE-LSA

The gain that is applied to the noisy signal in the frequency domain in the hybrid speech enhancement system according to the principles of the invention is different than the gain that is applied in the frequency domain according to the modified MMSE-LSA technique developed by Malah.

In the modified MMSE-LSA approach developed by Malah, we consider clean speech x[n] that has been contaminated with uncorrelated additive noise w[n] to produce noisy speech y[n]:

y[n]=x[n]+w[n] (56)

In the frequency domain, we have

Yₖ=Xₖ+Wₖ (57)

where

Xₖ=Aₖe^{J}^{^{φ}}^{k} (58)

Yₖ=Rₖe^{J}^{^{θ}}^{k} (59)

We now estimate Aₖ by minimizing the log-spectral amplitude in a MMSE sense:

$${\hat{A}}_{k} = {arg min}_{B} E [ {( log {A}_{k} - log B )}^{2} ] \qquad ( 60 )$$

so the enhanced signal (in the frequency domain) becomes

\hat{X}ₖ=Âₖe^{J}^{^{θ}}^{k} (61)

It turns out that Aₖ can be computed by simply applying a gain in the frequency domain:

Âₖ=G(εₖ,γₖ)·Rₖ (62)

where G(εₖ,γₖ) is a complicated function of the a-priori and a-posteriori SNR's εₖ and γₖ.

On the other hand, the gain applied in the frequency domain by the hybrid speech enhancement system in accordance with the principles of the invention is closer to that used in the signal subspace approach developed by Ephraim, but is still fundamentally different. We begin in vector notation with

y=x+w (63)

and estimate the clean speech by filtering the noisy speech with a linear filter H:

\hat{x}=Hy (64)

We can decompose the residual error into a term solely dependent on the clean speech, called the signal distortion rₓ, and a term solely dependent on the noise, called the residual noise r_{w}:

$$\begin{matrix}r = \hat{x} - x \\ = ( H - I ) x + Hw \\ = {r}_{x} + {r}_{w}\end{matrix} \qquad ( 65 )$$

H is chosen so as to minimize the signal distortion energy while keeping the residual noise constrained in the frequency domain:

H=arg min\overline{ε}ₓ² such that Sᵣ_{_{w}}ᵣ_{_{w}}(k)≦αₖS_{ww}(k) (66)

Here \overline{ε}ₓ²=tr E[rₓrₓ^{#}] is the signal distortion energy, Sᵣ_{_{w}}r_{_{w}}(k) is the k^{th} spectral coefficient of the residual noise r_{w}, S_{ww}(k) is the k^{th} spectral coefficient of the noise w, and the αₖ are constants. H turns out to (approximately) apply a gain to each frequency component of the noisy speech:

Âₖ=Gₖ·Rₖ (67)

where

Gₖ=\sqrt{αₖ} (68)

### III.C. Modular Structure

Referring to FIG. 4, the hybrid speech enhancement system includes the core estimator 38 along with the support modules that perform the noise adaptation 34, SNR estimation 36, and soft decision gain calculation 40 tasks. The core estimator 38 of the hybrid speech enhancement system performs a short-time spectral amplitude (STSA) speech enhancement process in the frequency domain by modifying the spectral amplitude of the noisy speech without touching the phase (i.e. using the noisy phase). According to the principles of the invention, the purpose of the core estimator 38 in the hybrid speech enhancement system shown in FIG. 4 is to provide a gain for each frequency bin of the spectral amplitude of the noisy speech. The core estimator 38 is constructed to take advantage of the other modules (for example, by making direct use of the estimated SNR's from the SNR estimator 36).

The noise adaptation processor 34 segments the noisy speech into noise-only and signal-containing frames, and is responsible for maintaining a current estimate of the noise spectrum as well as an estimate of the probability of signal presence in each frequency bin. These parameters are used when estimating the SNR's, and also impact the core estimator and soft decision gains directly. For example, during a noise-only frame a constant gain is applied to the noise in order to avoid noise structuring.

Given the noise estimate λ_{w}(k), two SNR's are computed. The a-posteriori SNR, γₖ, is directly measured, while the a-priori SNR, ξₖ, is estimated using the decision-directed approach.

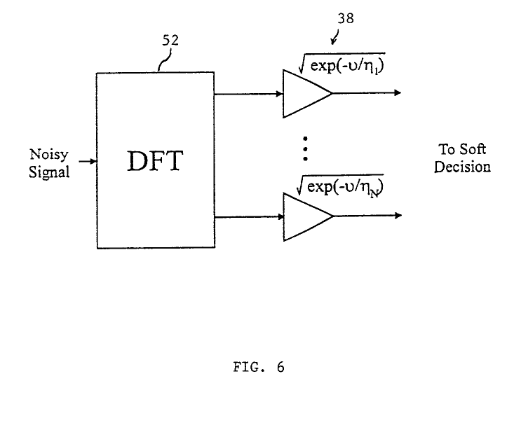

A second embodiment of the core estimator 38 (FIG. 4) is illustrated in FIG. 6, along with a DFT 52. The core estimator 38 is coupled to the DFT 52. The DFT 52 receives the noisy speech signal containing an original amount of noise. The DFT 52 transforms the noisy signal containing the original noise into DFT coefficients in the frequency domain. After the noisy signal is transformed into the frequency domain, the core estimator applies a set of gains, Gₖ=\sqrt{αₖ}, to the DFT coefficients in the frequency domain and outputs noisy speech containing a residual noise. Here the energy of the signal distortion is minimized with the residual noise constrained by the αₖ's. We developed a set of constraints for the αₖ's:

$${G}_{k} = \sqrt{exp ( - υ / {η}_{k} )} , where {η}_{k} = \frac{{ξ}_{k}}{1 - {q}_{k}} \qquad ( 69 )$$

and ν is some constant indicating the level of aggression of the speech enhancement. In the second embodiment of the core estimator 38 depicted in FIG. 6, these gains described by (69) are applied to the DFT coefficients received from the DFT 52. After the core estimator 38 applies the gains to the DFT coefficients of the noisy speech, the noisy signal is passed to the soft decision module 40 (FIG. 4) for further enhancement.

In the hybrid speech enhancement system, the soft decision module 40 of FIG. 4 operates in the frequency domain to apply a second set of gains to further enhance the noisy signal. For each frequency bin, the soft decision module 40 computes a gain that is applied to the spectral amplitude of the noisy speech in the frequency domain. The gain for each frequency bin is based on the a-posteriori SNR, the a-priori SNR and the probability of signal absence in each frequency bin, qₖ.

The hybrid speech enhancement system illustrated by FIGS. 4, 5 and 6 provides the ability to place constraints on the signal distortion or residual noise energy in the frequency domain yielding a greater flexibility than the modified MMSE-LSA approach developed by Malah. Some of the constraints which can be placed include using soft decision rather than removing noise-only subspace, which results in a less artificial sounding noise. More specifically, the power spectral density of the residual noise is constrained to be below a constant proportion of the original noise power spectral density. The constraints are manipulated so as to fit into the decision-directed approach. The gain applied can depend on signal presence uncertainty, or not.

An important advantage of the hybrid speech enhancement system as compared to the signal subspace approach developed by Ephraim is the improved performance gained from making use of the modified MMSE-LSA framework. The noise adaptation processor, decision-directed SNR estimator, and soft decision module all help in reducing noise distortion and providing a better trade-off between speech distortion and noise reduction than obtainable with the signal subspace approach alone.

While several particular forms of the invention have been illustrated and described, it will also be apparent that various modifications can be made without departing from the spirit and scope of the invention.

What is claimed is:

1. A speech enhancement system, comprising:
a noise adaptation module receiving noisy speech,
the noisy speech being characterized by spectral coefficients spanning a plurality of frequency bins and containing an original noise,
the noise adaptation module segmenting the noisy speech into noise-only frames and signal-containing frames, and
the noise adaptation module determining a noise estimate and a probability of signal absence in each frequency bin;
a signal-to-noise ratio estimator coupled to the noise adaptation module,
the signal-to-noise ratio estimator determining a first signal-to-noise ratio and a second signal-to-noise ratio based on the noise estimate; and
a core estimator coupled to the signal-to-noise ratio estimator and receiving the noisy speech,
the core estimator applying to the spectral coefficients of the noisy speech a first set of gains in the frequency domain without discarding the noise-only frames to produce speech that contains a residual noise,
wherein the first set of gains is determined based, at least in part, on the second signal-to-noise ratio and a level of aggression, and
wherein the core estimator is operative to maintain the spectral density of the spectral coefficients of the residual noise below a proportion of the spectral density of the spectral coefficients of the original noise.

2. The system of claim 1, wherein:
each one of the first set of gains is also based on the probability of signal absence in each frequency bin.

3. The system of claim 1, wherein:
the system modifies the spectral amplitude of the noisy speech without affecting the phase of the noisy speech.

4. The system of claim 1, wherein:
during a noise-only frame, a constant gain is applied to the noise in order to avoid noise structuring.

5. The system of claim 1, wherein:
the core estimator applies to the spectral coefficients of the noisy speech one of the first set of gains for each frequency bin.

6. The system of claim 1, further comprising:
a soft decision module coupled to the signal-to-noise ratio estimator and to the core estimator,
the soft decision module applying a second set of gains to the spectral coefficients of the speech that contains a residual noise.

7. The system of claim 6, wherein:
the soft decision module determines the second set of gains based on the first signal-to-noise ratio, the second signal-to-noise ratio and the probability of signal absence in each frequency bin.

8. A method for enhancing speech, comprising the steps of:
receiving noisy speech,
wherein the noisy speech is characterized by spectral coefficients spanning a plurality of frequency bins and contains an original noise;
segmenting the speech into noise-only frames and signal-containing frames;
determining a noise estimate and a probability of signal absence in each frequency bin;
determining a first signal-to-noise ratio and a second signal-to-noise ratio based on the noise estimate;
determining a first set of gains based, at least in part, on the second signal-to-noise ratio and a level of aggression; and
applying the first set of gains to the spectral coefficients of the noisy speech without discarding the noise-only frames to produce speech that contains a residual amount of noise, such that the spectral density of the spectral coefficients of the residual noise is maintained below a proportion of the spectral density of the spectral coefficients of the original noise.

9. The method of claim 8, wherein:
the first set of gains is also based on the probability of signal absence in each frequency bin.

10. The method of claim 8, further comprising the step of:
modifying the spectral coefficients of the noisy speech without affecting the phase of the noisy speech.

11. The method of claim 8, further comprising the step of:
during a noise-only frame, applying a constant gain to the noise.

12. The method of claim 8, wherein:
one of the first set of gains is applied to the spectral coefficients of the noisy speech for each frequency bin.

13. The method of claim 8, further comprising the step of:
applying a second set of gains to the spectral coefficients of the speech that contains a residual noise.

14. The method of claim 13, further comprising the step of:
determining the second set of gains based on the first signal-to-noise ratio, the second signal-to-noise ratio and the probability of signal absence in each frequency bin.
